(19) United States
(12) Patent Application Publication
(10) Pub. No.: US 2021/0109016 A1
(43) Pub. Date: Apr. 15, 2021

(54) SPECTROPHOTOMETRIC MEASUREMENT ESTIMATION

(71) Applicant: Hewlett-Packard Development Company, L.P., Spring, TX (US)

(72) Inventors: Nir Guttman, Nes Ziona (IL); Dan Ben Yaakov, Nes Ziona (IL); Ziv Berkovich, Nes Ziona (IL)

(73) Assignee: Hewlett-Packard Development Company, L.P., Spring, TX (US)

(21) Appl. No.: 16/965,072

(22) PCT Filed: Mar. 13, 2018
(86) PCT No.: PCT/US2018/022152

§ 371 Date: Jul. 27, 2020

(51) Int. Cl. G01N 21/33; G01J 3/50

(52) U.S. Cl. CPC G01N 21/33; G01J 3/50

(57) ABSTRACT

A method is provided. The method comprises receiving a signal representative of a first combined spectrophotometric response of a substrate and deposited colorant. The first combined spectrophotometric response is indicative of a combined reflectance of the substrate and deposited colorant under a first illumination condition. The method further comprises determining, from the received signal, and from a contribution term indicative of an effect of ultra-violet, UV, light on a combined reflectance of the substrate and deposited colorant, an estimate for a second combined spectrophotometric response of the substrate and deposited colorant under a second illumination condition. The first illumination condition or the second illumination condition is a UV-cut illumination condition.

### BACKGROUND

Spectrophotometric measurement is used for colour calibration so that reproduced colours match corresponding target values as well as possible. Spectrophotometric measurement and colour calibration is useful for high quality colour printing devices. For example, a spectrophotometer, spectrophotometric measurement device or spectrophotometric measurement system can greatly assist in keeping a printing device or press colour consistent and repeatable.

### BRIEF DESCRIPTION OF THE DRAWINGS

Examples are further described hereinafter with reference to the accompanying drawings, in which:

FIG. 1 shows a flowchart of a method according to some examples;

FIG. 2 shows at least a part of an apparatus and printing device according to some examples;

FIG. 3 is a block diagram of a machine-readable medium according to some examples;

FIG. 4 shows four line graphs of various quantities utilized during a semi-analytical estimate of the contribution of UV light to a measured reflectance;

FIG. 5 shows a line graph of an average Euclidean distance between colour measurements as a function of a power parameter;

FIG. 6 shows a deposited layer of a colorant on a substrate and light passing therethrough;

FIG. 7 shows a line graph of an average Euclidean distance between colour measurements as a function of a power parameter; and

FIG. 8 is a flowchart of a method according to some examples.

Throughout the description and the drawings, like reference numerals refer to like parts.

### DETAILED DESCRIPTION

It can be difficult to match spectrophotometric measurement devices due to differences between the devices, such as mechanical tolerances, and differences between the local conditions under which the spectrophotometric measurement devices operate, for example, a change in illumination conditions often leads to a change in the reflectance of an object as measured by the spectrophotometric device.

Broadly speaking, the possible differences can be categorized as statistical differences, systematic differences, and sample related systematic differences. Statistical differences relate to the amount of measurement time and light reflected from a sample—this leads to inherent uncertainty in any spectrophotometric measurement. Systematic differences relate to mechanical tolerances, such as height differences, angle differences, or visible light illumination.

Sample related systematic differences may be related to ultraviolet, UV, illumination. For example, some printing liquids or colorants absorb UV light and reemit visible light. As another example, some substrates (onto which a printing liquid or colorant may be deposited by a printing device or press) may absorb UV light and reemit visible light, particularly when the substrate contains one or more optical brighteners, which are commonly used in white substrates. This conversion of UV light to visible light, which may be detected by a spectrophotometric device, may confound spectrophotometric measurements leading to inconsistencies in press/printing device performance.

In what follows, the term “printing device” or “press” is sometimes used. These terms may be used interchangeably and may represent any suitable printing device, printing apparatus or printing system. A printing device as used herein is a device that processes some form of computer-readable instructions to render a representation of information to a substrate, for example paper.

The terms “spectrophotometer”, “spectrophotometric device”, “spectrophotometric apparatus” and similar are sometimes used in the following discussion and are used interchangeably. For the purposes of this discussion, a spectrophotometer is a device/apparatus/system capable of measuring the intensity of light as a function of its wavelength or frequency. The spectrophotometer may comprise, for example, a spectrophotometric sensor capable of receiving light and producing an output signal. For the purposes of this disclosure, a spectrophotometer and/or a spectrophotometric sensor may be considered as a device or component capable of receiving light reflected from a surface of an object and output a signal that can be used to evaluate the reflectance of the surface. The signal is usually indicative of the received electromagnetic radiation as a function of the wavelength/frequency of the radiation.

Of relevance to the present application is ultra-violet light. The term “light” as used herein is used to refer to electromagnetic radiation. Ultra-violet (UV) light is electromagnetic radiation having a wavelength from between about 10 nm to about 400 nm, although the electromagnetic spectrum is a continuum and the skilled person would appreciate that the boundary wavelengths/frequencies of the “UV region” of the electromagnetic spectrum are not exact. UV light has a smaller wavelength than visible light; visible light has a wavelength of between about 400 nm to about 700 nm and is visible to a human eye.

Some colorants, and optical brighteners in some substrates, absorb UV radiation and, through an electrophysical change, emit visible light. Accordingly, an image/copy/piece printed on a substrate may appear differently or be perceived differently under different lighting conditions, dependent on whether the illumination source used includes UV light. The International Organization for Standardization (ISO) introduced, as part of ISO 13655-2009: “Graphic technology—Spectral measurement and colorimetric computation for graphic arts images” an “M series” of standardized measurement illumination conditions appropriate for different applications.

In what follows, the M2 measurement illumination condition is used as a shorthand for UV excluded (UV-cut, No UV, or UV-filtered) light. That is, UV-cut light may be referred to herein, and may substantially correspond to the M2 measurement illumination condition. The skilled person would appreciate that a term such as “UV-cut” light or similar as used herein may or may not correspond to the M2 measurement illumination condition.

Similarly, in what follows, the measurement illumination conditions M0 and M1 are sometimes referred to. In the context of the present application, these measurement illumination conditions are used as a shorthand for an illumination condition in which UV light is present. The skilled person would appreciate that these measurement illumination conditions are therefore referred to for demonstrative purposes, and that an illumination condition in which UV light is present may or may not correspond to one of the measurement illumination conditions M0 and M1.

Throughout the description and claims of this specification, the words “comprise” and “contain” and variations of them mean “including but not limited to”, and they are not intended to (and do not) exclude other components, integers or operations. Throughout the description and claims of this specification, the singular encompasses the plural unless the context demands otherwise. In particular, where the indefinite article is used, the specification is to be understood as contemplating plurality as well as singularity, unless the context demands otherwise.

According to some examples, a method is described herein. The method comprises receiving a signal representative of a first combined spectrophotometric response of a substrate and deposited colorant, the first combined spectrophotometric response indicative of a combined reflectance of the substrate and deposited colorant under a first illumination condition. The method further comprises determining, from the received signal, and from a contribution term indicative of an effect of ultra-violet, UV, light on a combined reflectance of the substrate and deposited colorant, an estimate for a second combined spectrophotometric response of the substrate and deposited colorant under a second illumination condition. The first illumination condition or the second illumination condition is a UV-cut illumination condition. That is, the first illumination condition or the second illumination condition is an illumination condition in which there is no UV light/UV light has been filtered out. The UV-cut illumination condition may correspond to an M2 measurement illumination condition.

Such a method may operate at the level of the spectrum (e.g. the reflectance of the object) and enable estimation of a raw measurement as opposed to operating on colour values, such as e.g. LAB, CIELAB or CIEXYZ colour values. This can be relevant when calibrating some printing devices for example. Furthermore, such a method provides for a high level of accuracy and few prior measurements to determine the contribution term. A method as described herein may be used to calibrate a press or printing device and may be used as a diagnostic tool for a spectrophotometric measurement device since deviation from estimated measurements may indicate an error.

The contribution term may be representative of absorption of UV light in the deposited colorant. The contribution term may be dependent on a difference between a spectrophotometric response of the substrate under the first illumination condition and a spectrophotometric response of the substrate under the second illumination condition. The contribution term may be further representative of absorption of visible light in the deposited colorant.

Receiving a signal representative of the second spectrophotometric response may comprise measuring the first spectrophotometric response of the substrate and deposited colorant using a spectrophotometer.

In some examples, the first illumination condition may be the UV-cut condition. Determining the estimate for the second combined spectrophotometric response may comprise summing the combined reflectance of the substrate and deposited colorant under the first illumination condition and the contribution value.

In some examples, the second illumination condition may be the UV-cut condition. Determining the estimate for the second combined spectrophotometric response may comprise subtracting the contribution value from the combined reflectance of the substrate and deposited colorant under the first illumination condition.

In some examples, the method may further comprise determining, from the second combined reflectance, a third combined reflectance of the substrate and deposited colorant under a UV-cut illumination condition using a calibration factor, the calibration factor for converting a measurement by the first spectrophotometer to an inferred measurement by a second spectrophotometer. The third combined reflectance of the substrate and deposited colorant may be indicative of a reflectance of the substrate and deposited colorant as measured by the second spectrophotometer under the UV-cut illumination condition. In this way, the method may be used to calibrate a second spectrophotometer based on a measurement of a first spectrophotometer. The UV-cut illumination condition may correspond to a M2 measurement illumination condition.

In some examples, the method may further comprise determining, from the third combined reflectance and a second contribution term indicative of an effect of UV light on a combined reflectance of the substrate and deposited colorant, a fourth combined reflectance of the substrate and deposited colorant under an illumination condition in which UV light is present. The illumination condition may correspond to a M0 measurement illumination condition. The illumination condition may correspond to a M1 measurement illumination condition.

Methods described herein may be implemented using one or more processors. Instructions for causing the one or more processors to carry out the methods may be stored on computer readable medium (such as memory, optical storage medium, RAM, ROM, ASIC, FLASH memory, etc.) The medium may be transitory (e.g. a transmission medium) or non-transitory (a storage medium).

According to some examples, a non-transitory machine-readable storage medium is provided, the non-transitory machine-readable medium encoded with instructions executable by a processor. The machine-readable medium comprises instructions to determine, from received data representative of a first combined spectrophotometric response of a substrate and deposited colorant under a first illumination condition, and from a contribution term indicative of an effect of ultra-violet, UV, light on a combined reflectance of the substrate and deposited colorant, an estimate for a second combined spectrophotometric response of the substrate and deposited colorant under a second illumination condition. The first combined spectrophotometric response may be indicative of a combined reflectance of the substrate and deposited colorant under the first illumination condition. The second combined spectrophotometric response may be indicative of a combined reflectance of the substrate and deposited colorant under the second illumination condition. The first illumination condition or the second illumination condition may be a UV-cut illumination condition.

The machine-readable storage medium may further comprise instructions to determine, from the second combined reflectance, a third combined reflectance of the substrate and deposited colorant under a UV-cut illumination condition using a calibration factor, the calibration factor for converting a measurement by the first spectrophotometer to an inferred measurement by a second spectrophotometer. The third combined reflectance of the substrate and deposited colorant may be indicative of a reflectance of the substrate and deposited colorant as measured by the second spectrophotometer under the UV-cut illumination condition.

In some examples, the machine-readable storage medium may comprise instructions to determine, from the third combined reflectance and a second contribution term indicative of an effect of UV light on a combined reflectance of the substrate and deposited colorant, a fourth combined reflectance of the substrate and deposited colorant under an illumination condition in which UV light is present. The fourth combined reflectance of the substrate and deposited colorant may be indicative of a reflectance of the substrate and deposited colorant as measured by the second spectrophotometer under the illumination condition in which UV light is present.

In some examples, an apparatus is provided. The apparatus comprises a spectrophotometer to receive light reflected from a printed face of a substrate and to produce an output signal representative of the spectral reflectance of the printed face of the substrate under a first illumination condition. The apparatus further comprises a memory. The apparatus further comprises a controller to receive the output signal and to process instructions stored in the memory to determine, from the combined spectral reflectance of the substrate and deposited colorant, and from a contribution term stored in the memory, an estimate for the spectral reflectance of the printed face of the substrate under a second illumination condition. The contribution term is indicative of an effect of ultra-violet, UV, light on a reflectance of a printed liquid on a substrate. The first illumination condition or the second illumination condition may be an illumination condition in which UV light is substantially absent.

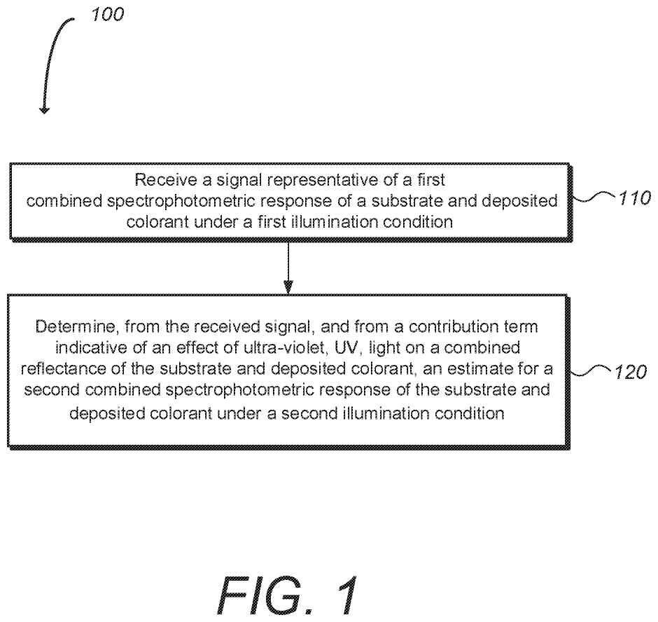

FIG. 1 is a flowchart of method 100 according to an example. The method may be used to determine a transformation between reflectance values that would be measured by a spectrophotometer based on two different illumination conditions, one of which is a UV-cut illumination condition. The method may be performed by one or more processors of a computing device.

At 110, a signal is received. The signal is representative of a first combined spectrophotometric response of a substrate and deposited colorant under a first illumination condition. For example, the signal may result from a measurement using a spectrophotometer.

At 120, an estimate for a second combined spectrophotometric response of the substrate and deposited colorant under a second illumination condition is determined. The determination is made based on the received signal and a contribution term, the contribution term indicative of an effect of ultra-violet, UV, light on a combined reflectance of the substrate and deposited colorant. More detail on how such a determination may be made will be provided below.

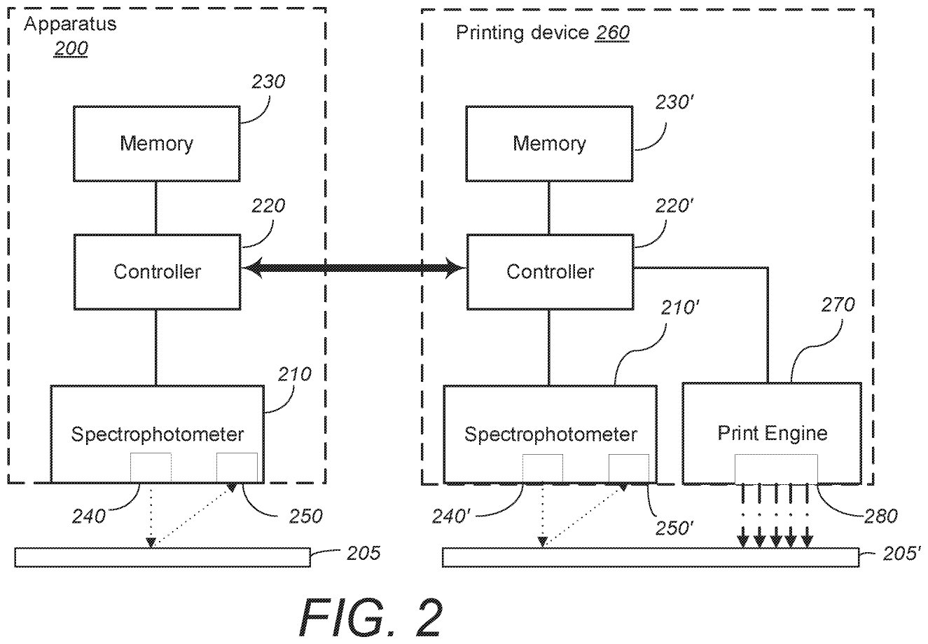

FIG. 2 is a block diagram showing at least a part of an apparatus 200 and at least a part of a printing device 260. The components shown in FIG. 2 are relevant to the present application but the skilled person would appreciate that other components may be present, as will be explained further below.

Apparatus 200 is shown in FIG. 2 to comprise a spectrophotometer 210, a controller 220 coupled to the spectrophotometer 210, and a memory coupled to the controller. Other architectures to that shown in FIG. 2 may be used as will be appreciated by the skilled person. For example, the apparatus 200 may be a handheld device.

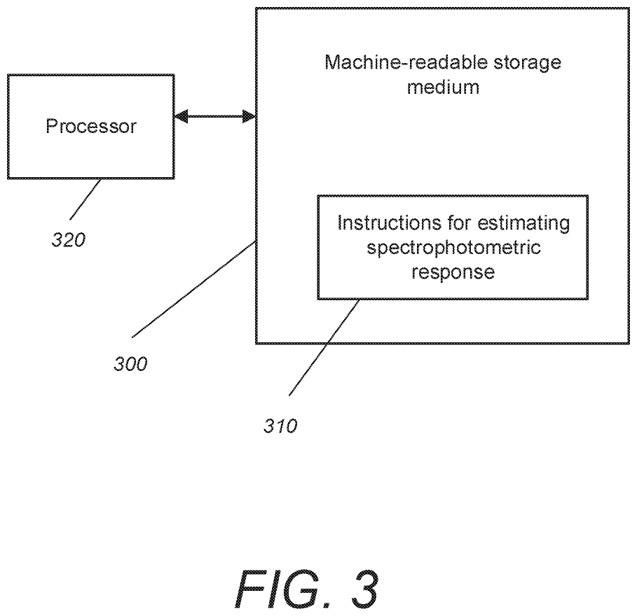

For example, the apparatus 200 may include one or several user interfaces including visualizing means such as a visual display, a virtual or dedicated keyboard, a microphone and/or one or more auxiliary user interfaces. The apparatus 200 may comprise a communications module for sending and receiving communications between controller 220 and other devices (for example the controller 220′ of printing device 260). The communications module may be used to send and receive communications via a network such as the Internet. The apparatus 200 may comprise a USB port or other connection interface for receiving, for example, a non-transitory computer-readable medium (300, FIG. 3) containing instructions to be processed by the controller 220.

The spectrophotometric sensor 210 of the apparatus 200 is suitable for spectrophotometric measurement by receiving light reflected from a surface of a substrate 205 (with or without colorant deposited thereon) and is suitable for producing a signal, output to the controller 220, that can be used to represent the reflectance of the substrate 205. The spectrophotometer 210 is arranged to receive light reflected from the substrate 205. The spectrophotometric sensor comprises a light source 240 which is capable of illuminating the substrate 205 under a first illumination condition (for example in which UV light is present), and light that is reflected back from the substrate may be received by light-receiving areas such as light-receiving area 250. The spectrophotometer 210 produces an output signal which can represent the spectrum of the light received, as will be explained further below. The controller 220 receives the output signal from the spectrophotometer.

The spectrophotometer 210 may or may not include the light source 240. In some examples in which the spectrophotometer includes the light source 240, the spectrophotometer may further include light receiving areas 250 which form a circle or a ring around a centrally arranged light source 240 so that the light source 240 is surrounded by the light receiving areas 250.

In an example the light from the light source 240 is directed in an orthogonal direction (i.e. substantially 0 degrees) relative to the substrate or surface of the substrate on which a spectrophotometric measurement is to be performed, e.g. on a surface of a printed substrate. The light incident on the object is then substantially reflected back to the light receiving area 250 of the sensor. In some examples, the light is reflected at an angle relative to a direction normal to the surface of the object. In some examples the angle is acute, e.g. less than or equal to 45 degrees. In such examples, the light-receiving area(s) 250 receives light emitted from the central light source 240 and reflected by the substrate 205 at a range of reflection angles approximately defined by the dimensions of the formation (e.g. the radius of the ring or circle) which defines the light-receiving area 250 and the distance between substrate 205 and sensor 250.

The controller 220 may comprise one or more processors. The controller 220 is configured to receive data, access the memory 230, and to act upon instructions received either from said memory 230, from a communications module (not shown) or from a user input device (not shown). In particular, the controller 220 is configured to receive a signal from the spectrophotometer 210, the signal representative of a reflectance of the surface of the substrate 205 (and colorant) as measured by the spectrophotometer 210 in a first illumination condition. The controller 220 is further configured to infer or determine an estimate for the reflectance of the substrate 205 as would be measured by the spectrophotometer 210 under a second illumination condition (for example in which there is no UV light shining onto the substrate 205). The determination of the second spectrophotometric response is determined from the received signal from the spectrophotometer 210 and from a contribution factor that the controller 220 is able to retrieve from the memory 230 or determine based on instructions and/or values stored in the memory 230, and/or received via a connection interface or communications module.

The controller 220 is further arranged to output the determined estimate for the spectrophotometric response of the substrate 205 under the second illumination condition. For example, the controller may output the determined second spectrophotometric response to a visual display (not shown) of the apparatus 200, or may communicate said determined spectrophotometric response in some other way, for example via a communications module (not shown) of the apparatus 200.

In FIG. 2 the apparatus 200 is shown to be in communication with a printing device 260 (as indicated by the double headed arrow). The printing device 260 similarly comprises at least a spectrophotometer 210′ provided with an illumination source 240′ and a light receiving area/region 250′. The spectrophotometer 210′ of the printing device 260 is also coupled to a controller 220′, which in turn is coupled to a memory 230′. The printing device 260 further comprises a print engine 270 having a printing head 280 to print on a surface of a substrate 205′. The skilled person would appreciate that other architectures for the printing device 260 may be used.

As with the first spectrophotometer 210 of the apparatus 200, the second spectrophotometer 210′ of the printing device 260 is also arranged to receive light reflected from a surface of a substrate 205′ (and deposited colorant if appropriate). The spectrophotometer 210′ has an illumination source 240′ arranged to illuminate the surface of the substrate 205′ and a light-receiving portion 250′ for receiving light reflected from the substrate 205′. The second spectrophotometer 210′ is arranged to generate/produce an output signal representative of the reflectance of the substrate 205′ and communicate said signal to the controller 220′ of the printing device 260.

In some examples, the controller 220′ is configured to receive data indicative of the estimate of the second spectrophotometric response from the controller 220 of the apparatus 200. In some examples, the data is received via a communications module (not shown). The controller 220′ may be arranged to retrieve a calibration factor from the memory 230′ and to combine said calibration factor with the second spectrophotometric response to determine a third spectrophotometric response, the third spectrophotometric response representative of a reflectance of a substrate (205 or 205′) as would be measured by the second spectrophotometer 210′ of the printing device 260 under the second illumination condition (e.g. a UV cut condition). The calibration factor is a predetermined factor for converting a measurement by the first spectrophotometer 210 of the apparatus 200 to an inferred measurement by the second spectrophotometer 210′ of the printing device 260. The calibration factor may be determined in any suitable way (and examples will be discussed further below), but one suitable way been described by the inventors in international patent application number PCT/EP2016/000886 filed on 31 May 2016 and published on 7 Dec. 2017 as publication number WO 2017/207013 A1, the contents of which is incorporated herein by reference. The calibration factor corrects for systematic differences between the spectrophotometer 210 of the apparatus 200 and the spectrophotometer 210′ of the printing device 260.

In other examples, the calibration factor is instead or additionally stored in the memory 230 of the apparatus 200, and the communication between the controller 220 of the apparatus and the controller 220′ of the printing device 260 may contain information indicative of the calibration factor, or the communicated estimation for the second spectrophotometric response may be communicated with the calibration factor already provided by the controller 220 of the apparatus 200.

The third spectrophotometric response (that is, the determined estimate of the second spectrophotometric response with the calibration factor applied) is indicative of the reflectance that the second spectrophotometer 210′ would likely measure from a substrate (205,205′) under the second illumination condition (when no UV light is illuminating the substrate 205,205′). The controller 220′ of the printing device 260 is further arranged to retrieve a second contribution term from the memory 230′ or to receive a second contribution term from the controller 220 of the apparatus 200, the contribution term indicative of an effect of UV light on a reflectance of the substrate 205, 205′. The controller 220′ is further configured to determine, from the third spectrophotometric response and the second contribution factor, a fourth spectrophotometric response, the fourth spectrophotometric response indicative of a reflectance of the substrate 205, 205′ as would be determined by the second spectrophotometer 210′ under the first illumination condition, which may to a good approximation be representative of the local conditions when the substrate is illuminated by the light source 240′ of the second spectrophotometer 210′. The controller 220′ may adjust settings of the print engine 270 in order to ensure print quality.

In this way, the apparatus 200 may be used to calibrate the printing device 260 by addressing sample related systematic sources of error, in particular the effects of UV absorbing components of the substrate, such as optical brighteners.

FIG. 3 illustrates a computer readable medium 300 according to some examples. The computer readable medium 300 stores units, with each unit including instructions 310 that, when executed, cause a processor 320 or other processing device to perform particular operations. The computer readable medium 300 includes instructions 310 that, when executed, cause a processing device 320 to determine, from received data representative of a first combined spectrophotometric response of a substrate and deposited colorant under a first illumination condition (e.g. in which there is UV light present), and from a contribution term indicative of an effect of ultra-violet, UV, light on a combined reflectance of the substrate and deposited colorant, an estimate for a second combined spectrophotometric response of the substrate and deposited colorant under a second illumination condition (e.g. in which there is no UV light present). The first combined spectrophotometric response may be indicative of a combined reflectance of the substrate and deposited colorant under the first illumination condition. The second combined spectrophotometric response is indicative of a combined reflectance of the substrate and deposited colorant under the second illumination condition. Either the first illumination condition or the second illumination condition is a UV-cut illumination condition.

The contribution term may be representative of absorption of UV light in the deposited colorant. The contribution term may also be representative of absorption of visible light in deposited colorant.

The contribution term may be dependent on a difference between a spectrophotometric response of the substrate under the first illumination condition (substantially without deposited colorant) and a spectrophotometric response of the substrate (substantially without deposited colorant) under the second illumination condition.

The machine readable medium 300 may further comprise instructions to determine, from the second combined reflectance, a third combined reflectance of the substrate and deposited colorant under a UV-cut illumination condition using a calibration factor, the calibration factor for converting a measurement by a first spectrophotometer to an inferred measurement by a second spectrophotometer. The third combined reflectance of the substrate and deposited colorant may be indicative of a reflectance of the substrate and deposited colorant as measured by the second spectrophotometer under the UV-cut illumination condition.

The machine readable medium 300 may further comprise instructions to determine, from the third combined reflectance and a second contribution term indicative of an effect of UV light on a combined reflectance of the substrate and deposited colorant, a fourth combined reflectance of the substrate and deposited colorant under an illumination condition in which UV light is present. The fourth combined reflectance of the substrate and deposited colorant may be indicative of a reflectance of the substrate and deposited colorant as measured by the second spectrophotometer under the illumination condition in which UV light is present. The units of the computer readable medium 300 may cause a processing device 320 to operate in accordance with any of the examples described herein.

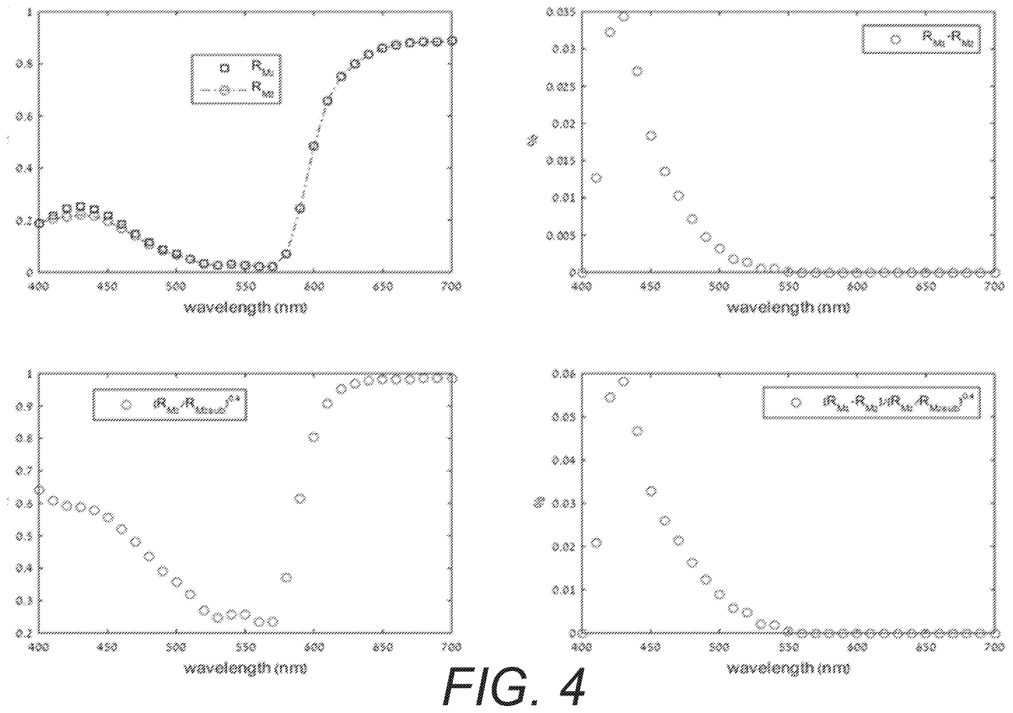

With reference to FIGS. 4, 5, 6 and 7, a discussion of the contribution term used to account for the effects of UV light will now follow.

The reflectance of a substrate, possibly having colorant deposited onto a surface thereof, when illuminated by electromagnetic radiation containing some quantity of UV light will often be represented as R_{M1} or R_{M0} in what follows. The illumination conditions represented by the subscripts M1 and M0 are described in the ISO standard 3664:2009. For the following discussion it will be assumed that the conditions correspond to M1 or M₀ conditions, however the following discussion is for demonstrative purposes and the scope of the claims should not be limited thereby—for example, an illumination condition in which UV light is present may not necessarily comply with the ISO standard referred to above.

The reflectance of a substrate, possibly having colorant deposited onto a surface thereof, when illuminated by electromagnetic radiation containing no UV light will often be represented as R_{M2} in what follows. The illumination conditions represented by the subscript M2 are described in the ISO standard ISO 3664:2009. For the following discussion, it will be assumed that the conditions correspond to M2 conditions, however the following discussion is for demonstrative purposes and the scope of the claims should not be limited thereby—for example, an illumination condition in which UV light is absent may not necessarily comply with the ISO standard referred to above.

The reflectance of a substrate (possibly with colorant deposited thereon) as measured by a spectrophotometer under an illumination condition in which UV light is present may be related to the reflectance of the substrate under an illumination condition in which UV light is absent by the following relation:

R_{M1}≈R_{M2}+C_{UV}

where C_{UV} is a contribution term representative of the sample-related effects of UV light on reflectance measurements. The contribution term may be derived as follows.

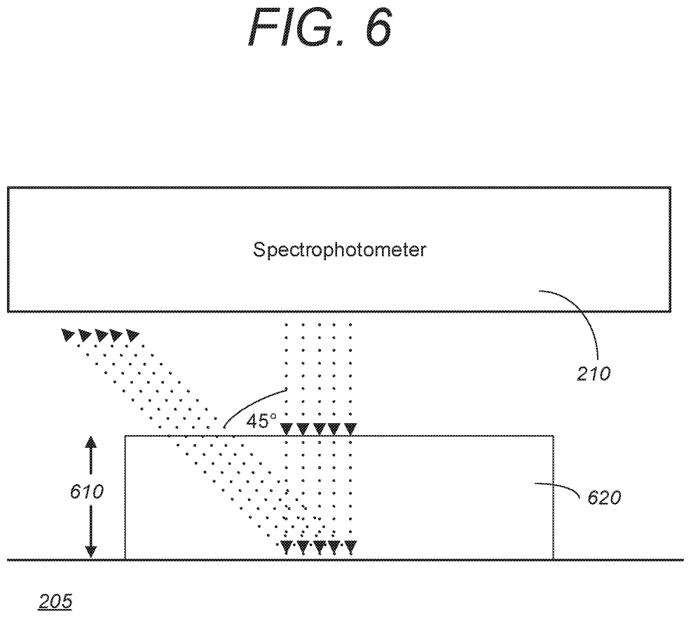

When light containing a UV component illuminates colorant (620, FIG. 6) deposited onto a substrate 205 (in FIG. 6 the light is shown as being emitted by the spectrophotometer 210 but this does not necessarily need to be so), the UV component is partially absorbed by the colorant 620. The UV light that is not absorbed by the colorant 620 may interact with optical brighteners in the substrate 205, and the energy may be transformed into visible light. The visible light may be partially absorbed by the colorant 620 but some visible light may be detected by the spectrophotometer 210.

The description of absorption of light in the colorant is approximately given by Beer's law:

R≈R^{substrate}e^{-Kd}

where R is the reflectance as measured by the spectrophotometer 210, R^{substrate} is the reflectance of the substrate as measured by the spectrophotometer 210 without colorant 620, K is a decay coefficient and d is the distance the light travels in the colorant layer. Accordingly, the ratio of R to R^{substrate} is approximately the decay due to light interacting with the colorant 620.

The UV component of the illumination makes maximal contribution to the measured reflectance of a substrate 205 when no colorant is applied to the substrate. In such a situation, there is no decay due to interactions between the UV component of the illumination and the colorant 620; the UV component merely interacts with any UV absorbing components (such as optical brighteners) in the substrate 205 leading to the emission of visible light. The maximal contribution of the UV component to reflectance can thus be describes as:

R_{UV}^{MAX}≈R_{M1}^{substrate}−R_{M2}^{substrate}

which is the difference between the reflectance measurements of the blank substrate under M1 and M2 conditions.

Accordingly, one can model the decay of the reflectance due to UV absorption in the colorant 620 by

R_{UV}≈R_{UV}^{MAX}e^{-Pl}

where P is a constant and l is a thickness of the deposited colorant (shown by reference numeral 610 in FIG. 6).

The light emitted from the substrate after the interaction with optical brighteners undergoes further absorption in the colorant layer 620. This absorption can be represented by

$${( \frac{{R}_{M 2}}{{R}_{M 2}^{substrate}} )}^{x} \approx {e}^{- Kdx}$$

where x is estimated to be less than 1 since the path of the light is shorter than d, the distance of the path that light travels, through the colorant 620, and back again to be detected by the spectrophotometer 210.

Using the above, the relationship between R₁ and R₂ can be estimated as:

$${R}_{1} \approx {R}_{2} + {R}_{UV}^{MAX} \cdot ( \frac{{R}_{UV}}{{R}_{UV}^{MAX}} ) \cdot {( \frac{{R}_{M 2}}{{R}_{M 2}^{substrate}} )}^{x}$$

from which the contribution term C_{UV} is discernable.

The contribution term may therefore carry information concerning the absorption of the UV light in the colorant or printed liquid layer (represented by the maximal UV contribution R_{UV}^{MAX} suppressed by the UV decay term) and the absorption/scattering of visible light.

A discussion will now follow of methods by which the parameters R_{UV} and x can be determined or estimated.

Estimating R_{UV} may be performed using a semi-analytical method such as a Yule-Nielsen model. According to this semi-analytical method, the spectral reflectance R_{UV} is assumed to be the weighted sum of the spectral reflectance of the i^{th} Neugebauer primary (which are functions of the wavelength λ) moderated by an exponent n. That is, the wavelength dependent function R_{UV} can be estimated by

$${R}_{UV} \approx {\sum }_{i} {( {A}_{i} ( C , M , Y , K ) \cdot {( {R}_{UV}^{i} ( λ ) )}^{n} )}^{1 / n}$$

where n is a Yule-Nielsen exponent. The weight vector Aᵢ(C, M, Y, K) is representative of the i^{th} Neugebauer primary, for example (100, 0, 0, 0) represents Cyan, (100, 100, 0, 0) represents a combination of Cyan and Magenta, and so on. Y represents yellow and K represents black colorant proportions in this context.

In order to estimate the reflectance R_{UV}, the difference between reflectance measurements when UV light is present (here taken to be an M1 illumination condition for convenience) and when UV is absent (here taken to be an M2 illumination condition for convenience) is given by R_{M1}ⁱ−R_{M2}ⁱ, moderated by a decay factor. That is, one approximates:

$${R}_{UV}^{i} = ( {R}_{M 1}^{i} - {R}_{M 2}^{i} ) / {( \frac{{R}_{M 2}^{i}}{{R}_{M 2}^{substrate}} )}^{x}$$

and where

R_{UV}^{substrate}=R_{UV}^{Max}.

FIG. 4 shows four graphs illustrating what the determined primary reflectance values may look like for Magenta (that is, when Aᵢ(C, M, Y, K) is (0, 100, 0, 0).

The top left graph of FIG. 4 shows the reflectance values Rₘ₁ⁱ (squares) and R_{M2}ⁱ (circles) as a function of wavelength λ. As can be seen in the top left graph, these values are much the same for most visible light wavelengths but there is a variation towards the bluer end of the spectrum. This is because when colorants absorb UV light and emit visible light, they tend to emit bluish light.

The top right graph of FIG. 4 shows the difference (R_{M1}ⁱ−R_{M2}ⁱ) as a function of wavelength λ.

The bottom left graph of FIG. 4 plots

$${( \frac{{R}_{M 2}^{i}}{{R}_{M 2}^{substrate}} )}^{x}$$

as a function of the wavelength λ when x is set to 0.6. The value x=0.6 is a suitable value to choose for the reasons that will be shown below.

The bottom right graph of FIG. 4 plots R_{UV}ⁱ as a function of wavelength λ.

One may use a numerical approach to estimating R_{UV}. A numerical approach may yield different results for different colorants and so the validity of a purely numerical approach should be tested in each particular case. One may assume that the absorption coefficient for UV light is similar in wavelength dependence to that of visible light but with a different exponent, as follows:

$${( \frac{{R}_{M 2}}{{R}_{M 2}^{substrate}} )}^{y} \approx ( \frac{{R}_{UV}}{{R}_{UV}^{MAX}} )$$

which leads to

$${R}_{M 1} \approx {R}_{M 2} + {R}_{UV}^{M A X} \cdot {( \frac{{R}_{M 2}}{{R}_{M 2}^{substrate}} )}^{x} \cdot ( \frac{{R}_{UV}}{{R}_{UV}^{MAX}} )$$

and so

$${R}_{M 1} \approx {R}_{M 2} + {R}_{UV}^{MAX} \cdot {( \frac{{R}_{M 2}}{{R}_{M 2}^{substrate}} )}^{x + y} .$$

One therefore may attempt to optimize a single parameter w=x+y. This method can be useful when no knowledge of the coverage values (C, M, Y, K) exists and spectral data alone is available.

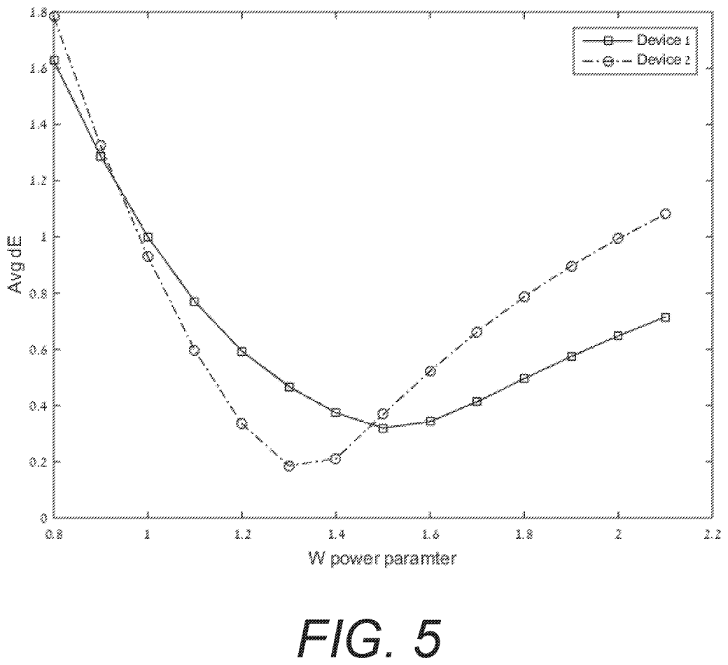

FIG. 5 shows the average Euclidean distance between two different colour coordinates (in Lab colour space) as a function of w, where the distance is taken between coordinates under M1 and M2 conditions. As can be seen from the figure, a value of w=1.4 is close to optimal.

The discussion above in relation to FIGS. 4 and 5 has concerned the estimation or determination of R_{UV}. A brief discussion will follow as to how one may determine the parameter x. One may estimate x using a theoretical model. One may estimate x using a numerical model.

For a theoretical estimation of x, with reference to FIG. 6, one can assume that the deposited colorant 620 has a uniform thickness l which is indicated in the figure by reference 610. Light may travel into the colorant from an illumination source 240 of the spectrophotometer 210 at an angle of substantially 0 degrees i.e. at an angle substantially perpendicular to the planar surface of the substrate 205 and exit at an angle of substantially 45 degrees. The length of the path through the colorant by which the total reflected light travels can therefore be approximated as (1+\sqrt{2})l. However, as described above, UV light from the spectrophotometer 210 is absorbed by the substrate 205 and emitted as visible light. The length of the path that the emitted visible light travels is approximately l \sqrt{2}. Accordingly, one can estimate x from the following series of equations:

$${R}_{M 2} \approx {R}_{M 2}^{substrate} {e}^{- Kl ( 1 + \sqrt{2} )} \\ \frac{{R}_{M 2}}{{R}_{M 2}^{substrate}} \approx {{e}^{- Kl ( 1 + \sqrt{2} )} \\ ( \frac{{R}_{M 2}}{{R}_{M 2}^{substrate}} )}^{x} \approx {e}^{- Kl ( \sqrt{2} )}$$

and so, one can estimate

$$x = \frac{\sqrt{2}}{( 1 + \sqrt{2} )} \approx 0.6 .$$

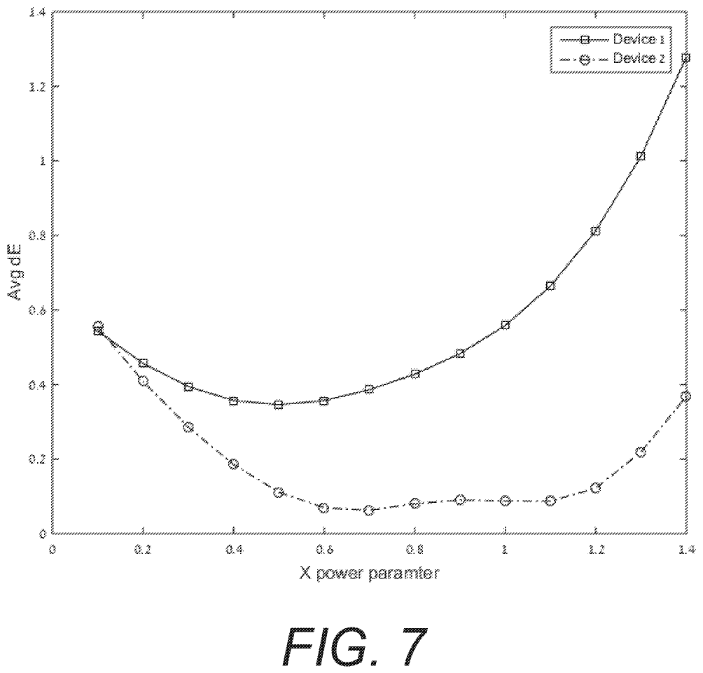

One may also estimate x numerically. In order to estimate x numerically, one follows the same procedures as for estimating R_{UV} numerically, but incorporates an estimation of the term (R_{UV}/R_{UV}^{MAX}) using the Yule-Nielsen model. FIG. 7 shows the average Euclidean distance of M2 against M1 measurements given different values for x. Both devices show good results around x=0.6.

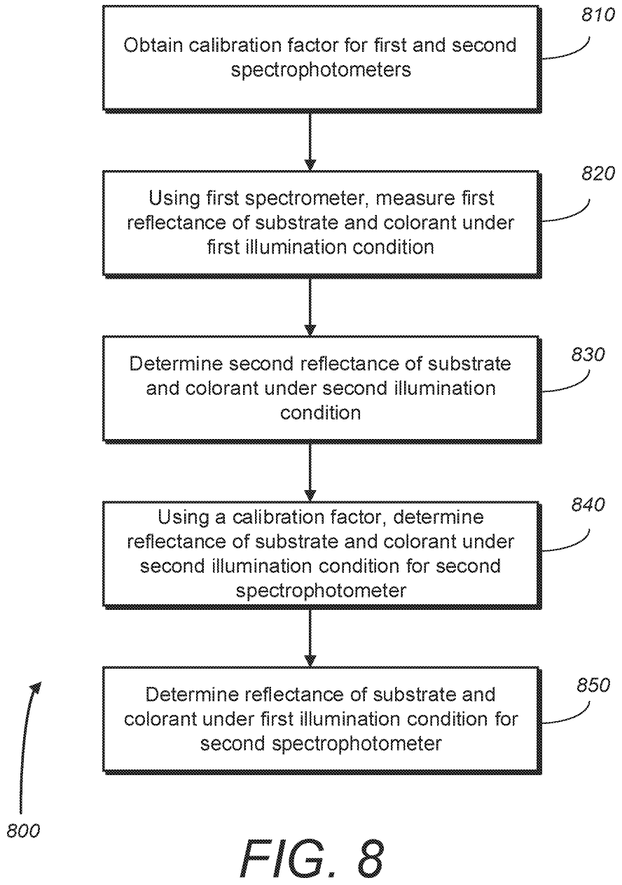

FIG. 8 is a flowchart of a method for addressing sample-related systematic differences between spectrophotometers. This method may be used, for example, in relation to the apparatus 200 and the printing device 260 of FIG. 2.

At 810, a calibration factor is obtained for the first and second spectrophotometers (210, 210′). The calibration factor allows for a correction of systematic differences between the spectrophotometers and can be obtained using any suitable method. In particular, a method for obtaining such a calibration factor can be found in international patent application number PCT/EP2016/000886 filed on 31 May 2016 and published on 7 Dec. 2017 as publication number WO 2017/207013 A1, the contents of which is incorporated herein by reference. The calibration factor may be wavelength dependent.

The calibration factor may be calculated as the ratio of the reflectance of a substrate in under M2 measurement illumination condition, or when the substrate contains no UV light-absorbing optical brighteners, as measured by the first spectrophotometer to the reflectance of the substrate under M2 measurement illumination conditions as measured by the second spectrophotometer to the reflectance of the substrate under M2 measurement illumination conditions. That is, the calibration factor c(λ) may be wavelength dependent and may be given by

$$c ( λ ) = \frac{{R}_{M 2 , First spect .}^{substrate}}{{R}_{M 2 , Second spect .}^{substrate}}$$

where R_{M2,First spect.}^{substrate} is the reflectance of the substrate under UV-cut illumination conditions as measured by the first spectrophotometer, and where R_{M2,Second spect.}^{substrate} is the reflectance of the substrate under UV-cut illumination conditions as measured by the second spectrophotometer.

At 820, a first reflectance of a substrate 205 and colorant 620 is measured using the first spectrophotometer 210 of the apparatus 200 under a first illumination condition in which UV light is present. For example, the first illumination condition may correspond to measurement illumination condition M1 or the measurement illumination condition M0.

At 830, a second reflectance of the substrate and colorant is determined using the measured first reflectance and a UV contribution factor as explained above in relation to FIGS. 4 to 7. The second reflectance is indicative of the reflectance of the substrate and colorant as would be determined by the spectrophotometer 210 under UV-cut illumination conditions, for example an M2 illumination condition.

At 840, using the second reflectance and the calibration factor, one can determine a third reflectance, the third reflectance indicative of what would be measured by the second spectrophotometer (210′) of the printing device (260) under UV-cut conditions.

At 850, from the determined third reflectance, a fourth reflectance is determined, the fourth reflectance indicative of the reflectance as would be measured by the second spectrophotometer 210′ of the printing device 260 under another illumination condition in which UV light is present. The fourth reflectance is determined from the third reflectance and a second contribution factor determined for the printing device 260 according to a method as described above in relation to FIGS. 4-7.

Variations of the described examples are envisaged, for example, the features of all of the disclosed examples may be combined in any way and/or combination, unless such features are incompatible.

Features, integers or characteristics described in conjunction with a particular aspect or example are to be understood to be applicable to any other aspect or example described herein unless incompatible therewith. All of the features disclosed in this specification (including any accompanying claims, abstract and drawings), and/or all of the elements of any method or process so disclosed, may be combined in any combination, except combinations where at least some of such features and/or operations are mutually exclusive. Implementations are not restricted to the details of any foregoing examples.

The disclosure is not restricted to the details of any foregoing examples. The disclosure extends to any novel one, or any novel combination, of the features disclosed in this specification (including any accompanying claims, abstract and drawings), or to any novel one, or any novel combination, of the features of any method or process so disclosed. The claims should not be construed to cover merely the foregoing examples, but also any examples which fall within the scope of the claims.

1. A method, the method comprising:
receiving a signal representative of a first combined spectrophotometric response of a substrate and deposited colorant, the first combined spectrophotometric response indicative of a combined reflectance of the substrate and deposited colorant under a first illumination condition; and
determining, from the received signal, and from a contribution term indicative of an effect of ultra-violet, UV, light on a combined reflectance of the substrate and deposited colorant, an estimate for a second combined spectrophotometric response of the substrate and deposited colorant under a second illumination condition;
wherein the first illumination condition or the second illumination condition is a UV-cut illumination condition.

2. A method according to claim 1, wherein the contribution term is representative of absorption of UV light in the deposited colorant.

3. A method according to claim 2, wherein the contribution term is dependent on a difference between a spectrophotometric response of the substrate under the first illumination condition and a spectrophotometric response of the substrate under the second illumination condition.

4. A method according to claim 2, wherein the contribution term is further representative of absorption of visible light in the deposited colorant.

5. A method according to claim 1, wherein receiving a signal representative of the second spectrophotometric response comprises measuring the first spectrophotometric response of the substrate and deposited colorant using a spectrophotometer.

6. A method according to claim 1, wherein the first illumination condition is the UV-cut condition and wherein determining the estimate for the second combined spectrophotometric response comprises summing the combined reflectance of the substrate and deposited colorant under the first illumination condition and the contribution value.

7. A method according to claim 1, wherein the second illumination condition is the UV-cut condition and wherein determining the estimate for the second combined spectrophotometric response comprises subtracting the contribution value from the combined reflectance of the substrate and deposited colorant under the first illumination condition.

8. A method according to claim 1, further comprising:
determining, from the second combined reflectance, a third combined reflectance of the substrate and deposited colorant under a UV-cut illumination condition using a calibration factor, the calibration factor for converting a measurement by a first spectrophotometer to an inferred measurement by a second spectrophotometer;
wherein the third combined reflectance of the substrate and deposited colorant is indicative of a reflectance of the substrate and deposited colorant as measured by the second spectrophotometer under the UV-cut illumination condition.

9. A method according to claim 8, further comprising:
determining, from the third combined reflectance and a second contribution term indicative of an effect of UV light on a combined reflectance of the substrate and deposited colorant, a fourth combined reflectance of the substrate and deposited colorant under an illumination condition in which UV light is present.

10. A non-transitory machine-readable storage medium encoded with instructions executable by a processor, the machine-readable storage medium comprising:
instructions to determine, from received data representative of a first combined spectrophotometric response of a substrate and deposited colorant under a first illumination condition, and from a contribution term indicative of an effect of ultra-violet, UV, light on a combined reflectance of the substrate and deposited colorant, an estimate for a second combined spectrophotometric response of the substrate and deposited colorant under a second illumination condition;
wherein the first combined spectrophotometric response is indicative of a combined reflectance of the substrate and deposited colorant under the first illumination condition;
wherein the second combined spectrophotometric response is indicative of a combined reflectance of the substrate and deposited colorant under the second illumination condition; and
wherein the first illumination condition or the second illumination condition is a UV-cut illumination condition.

11. A machine-readable storage medium according to claim 10, wherein the contribution term is representative of absorption of UV light in the deposited colorant.

12. A machine-readable storage medium according to claim 11, wherein the contribution term is dependent on a difference between a spectrophotometric response of the substrate under the first illumination condition and a spectrophotometric response of the substrate under the second illumination condition.

13. A machine-readable storage medium according to claim 10, further comprising:
instructions to determine, from the second combined reflectance, a third combined reflectance of the substrate and deposited colorant under a UV-cut illumination condition using a calibration factor, the calibration factor for converting a measurement by the first spectrophotometer to an inferred measurement by a second spectrophotometer;
wherein the third combined reflectance of the substrate and deposited colorant is indicative of a reflectance of the substrate and deposited colorant as measured by the second spectrophotometer under the UV-cut illumination condition.

14. A machine-readable storage medium according to claim 13, further comprising:
instructions to determine, from the third combined reflectance and a second contribution term indicative of an effect of UV light on a combined reflectance of the substrate and deposited colorant, a fourth combined reflectance of the substrate and deposited colorant under an illumination condition in which UV light is present;
wherein the fourth combined reflectance of the substrate and deposited colorant is indicative of a reflectance of the substrate and deposited colorant as measured by the second spectrophotometer under the illumination condition in which UV light is present.

15. An apparatus comprising:
a spectrophotometer to receive light reflected from a printed face of a substrate and to produce an output signal representative of the spectral reflectance of the printed face of the substrate under a first illumination condition;
a memory; and
a controller to receive the output signal and to process instructions stored in the memory to determine, from the combined spectral reflectance of the substrate and deposited colorant, and from a contribution term stored in the memory, an estimate for the spectral reflectance of the printed face of the substrate under a second illumination condition;
wherein the contribution term is indicative of an effect of ultra-violet, UV, light on a reflectance of a printed liquid on a substrate; and
wherein the first illumination condition or the second illumination condition is an illumination condition in which UV light is substantially absent.
